(19) United States
(12) Patent Application Publication
(10) Pub. No.: US 2022/0375315 A1
(43) Pub. Date: Nov. 24, 2022

(54) ADAPTING NOTIFICATIONS BASED ON USER ACTIVITY AND ENVIRONMENT

(71) Applicant: Google LLC, Mountain View, CA (US)

(72) Inventors: Alexander James Faaborg, Mountain View, CA (US); Michael Schoenberg, San Francisco, CA (US)

(21) Appl. No.: 17/303,014

(22) Filed: May 18, 2021

(51) Int. Cl. G08B 1/08

(52) U.S. Cl. CPC G08B 1/08

(57) ABSTRACT

According to a general aspect, a method can include receiving, by a computing device, an electronic communication. In response to receiving the electronic communication, the method can include determining, by the computing device, a current activity of a user of the computing device, and selecting, based on the determined current activity of the user, a communication channel of the computing device for providing a notification of the electronic communication. The method can also include providing the notification using the selected communication channel of the computing device.

### FIELD

This disclosure relates to providing notifications on an electronic device, such as a wearable device.

### BACKGROUND

Unless appropriate in quantity and type, notifications may feel interruptive on wearable devices such as smartglasses that visually display notifications overlaying the user's view of the world and/or provide audio notifications using audio output devices included in the wearable device. The user's attention is a limited resource, so the device has a responsibility to ensure that the user is exposed to relevant and meaningful notifications.

### SUMMARY

According to a general aspect, a method can include receiving, by a computing device, an electronic communication. In response to receiving the electronic communication, the method can include determining, by the computing device, a current activity of a user of the computing device, and selecting, based on the determined current activity of the user, a communication channel of the computing device for providing a notification of the electronic communication. The method can also include providing the notification using the selected communication channel of the computing device.

Implementations can include one or more of the following features. For example, determining the current activity of the user can include determining the current activity using one or more sensors included in the computing device.

The method can include, in response to receiving the electronic communication, determining, using one or more sensors of the computing device, data regarding an ambient environment of the user. Selecting the communication channel of the computing device for providing the notification can be further based on the data regarding the ambient environment of the user. Selecting the communication channel of the computing device for providing the notification can include selecting multiple communication channels of the computing device for providing the notification. Providing the notification can include providing the notification using the selected multiple communication channels of the computing device. The method can include selecting, based on the determined current activity of the user and the data regarding an ambient environment of the user, a format of the notification.

Selecting the communication channel of the computing device for providing the notification can include selecting the communication channel of the computing device for providing the notification using at least one machine learning (ML) model.

The method can include, in response to receiving the electronic communication, determining, by the computing device, a priority of the electronic communication. Selecting the communication channel of the computing device for providing the notification can be further based on the determined priority of the electronic communication.

Determining the current activity of a user of the computing device can include determining the user is visually engaged. In response to determining the user is visually engaged, selecting the communication channel of the computing device for providing a notification of the electronic communication can include selecting an audio communication channel of the computing device.

Determining the current activity of a user of the computing device can include determining the user is auditorily engaged. In response to determining that the user is auditorily engaged, selecting the communication channel of the computing device for providing a notification of the electronic communication can include selecting a text communication channel of the computing device.

The selected communication channel of the computing device for providing the notification can include an audio output channel. Providing the notification can include providing, via the audio output channel, an audio notification, the audio notification beginning with a name of the user.

Providing the notification can include providing the notification in accordance with a time delivery window. The electronic communication can be generated by the computing device; or received by the computing device via a data communication network.

According to another general aspect, a computing device can include at least one processor, and a non-transitory computer-readable medium storing executable instructions that, when executed by the at least one processor, cause the computing device to receive an electronic communication and, in response to receiving the electronic communication, determine a current activity of a user of the computing device, and select, based on the determined current activity of the user, a communication channel of the computing device for providing a notification of the electronic communication. The instructions, when executed by the at least one processor, can further cause the computing device to provide the notification using the selected communication channel of the computing device.

Implementations can include one or more of the following features. For example, the executable instructions can include instructions that, when executed by the at least one processor, cause the computing device to determine, using one or more sensors of the computing device, data regarding an ambient environment of the user. Selecting the communication channel of the computing device for providing the notification can be further based on the data regarding the ambient environment of the user.

The executable instructions can include instructions that, when executed by the at least one processor, cause the computing device to determine the current activity of the user using the one or more sensors of the computing device. The one or more sensors can include at least one of an eye gaze tracking sensor, a location sensor, an inertial measurement unit (IMU) sensor, an image sensor, a microphone, or a light sensor.

The computing device can include a wearable device.

According to another general aspect, a non-transitory computer-readable medium storing executable instructions that, when executed by at least one processor, cause the computing device to receive an electronic communication and, in response to receiving the electronic communication, determine a current activity of a user of the computing device, and select, based on the determined current activity of the user, a communication channel of the computing device for providing a notification of the electronic communication. The instructions, when executed by the at least one processor, can further cause the computing device to provide the notification using the selected communication channel of the computing device.

Implementations can include one or more of the following features. For example, the executable instructions can include instructions that when executed by the at least one processor cause the computing device to determine, using one or more sensors of the computing device, data regarding an ambient environment of the user. Selecting the communication channel of the computing device for providing the notification can be further based on the data regarding the ambient environment of the user. The executable instructions can include instructions that, when executed by the at least one processor, cause the computing device to select, based on the determined current activity of the user and the data regarding an ambient environment of the user, a format of the notification.

The executable instructions can include instructions that, when executed by the at least one processor, cause the computing device to determine a priority of the electronic communication. Selecting the communication channel of the computing device for providing the notification can be further based on the determined priority of the electronic communication.

### BRIEF DESCRIPTION OF THE DRAWINGS

FIG. 1A illustrates a computing device for providing adaptive (user) notifications according to an aspect.

FIG. 1B illustrates an example of a machine-learning (ML) model according to an aspect.

FIG. 1C illustrates an example of a ML model according to another aspect.

FIG. 2 is a flowchart illustrating a method for providing adaptive notifications according to an aspect.

FIGS. 3A and 3B are flowcharts illustrating method operations that can be implemented with the method of FIG. 2 for providing adaptive notifications.

FIG. 4 illustrates an example of a head-mounted display (wearable) device according to an aspect.

FIG. 5 illustrates example computing devices of the computing systems discussed herein according to an aspect.

### DETAILED DESCRIPTION

Providing notifications, e.g., electronic user notifications, using a computing device can be of great benefit to users of such device, as such notifications can inform a user of a number of different electronic communications, such as those associated with upcoming appointments (e.g., calendar notices and invites), incoming messages (e.g., email messages, text messages, etc.), news updates, phone calls, voicemails, etc. However, with the increase in use of computing devices, such as, wearable devices (e.g., smartglasses, smartwatches, etc.), providing such notifications can distract a user from a current activity (e.g., from a current sensory engagement or engagements), and/or can become an annoyance to the user if not properly managed and delivered.

For instance, one consideration when providing such notifications is that it is very difficult for people to effectively listen to, and understand two things at the same time, such as two people talking to the same person at the same time. Generally, a person will need to actively focus their attention on one audio source or the other, which will often then result in information from the other audio source not being effectively understood, received, and/or retained by the person.

Similarly, it is very difficult, or nearly impossible, for a person to read and comprehend two different passages of text at a same time. In order to effectively read one passage of text from a plurality of accessible passages, a user must adjust their gaze (line of sight, etc.) to an area of the passage of text they wish to read. Even if two different passages text are lined up with each, people are generally not able to read and understand two different text information sources concurrently and would need to choose one in favor of the other.

In view of this foregoing observations, this disclosure is directed to approaches for providing adaptive user notifications, where a communication channel for given notification is selected, e.g., using one or more machine learning (ML) models, and/or conventional programming logic, based on one or more current activities of the user and/or based on an environment of the user, such as a location of the user, ambient noise, etc. That is, using the approaches described herein, notifications can be provided in a communication channel that does not conflict with a sensory channel (or sensory) channel in which a user is engaged.

That is, this disclosure is directed to approaches for dynamically changing a communication channel, or medium of delivery for electronic notifications, such as switching between audio notifications, visual (text) notifications and/or a haptic notification, where a selected communication channel for a notification can be based on what activities the user is actively participating in at a time when the notification is to be delivered. For instance if the user is processing audio, or auditorily engaged (e.g., engaged in an audio sensory channel), such as participating in a conversation, listening to someone else speak, listening to a podcast, streaming audio, the approaches described herein can include selecting a visual communication channel, and/or haptic communication channel for delivery of any notifications while the user is so engaged. If, instead, a user is visually engaged (e.g., engaged in a visual sensory channel), such actively reading something, such as a book, text on a smartphone, text on smartglasses, a document, etc., the approaches described herein can includes selecting an audio, and/or non-text based communication channel (e.g., a haptic feedback device). If, instead, a user is both visually engaged and auditorily engaged, such as watching a movie, the approaches described herein can include a haptic communication channel for providing notifications to a user.

While the described approaches are generally discussed in the context of smartglasses implementations, it will be appreciated that the described approaches can be implemented using other appropriate devices. For instance, the disclosed techniques can be implemented using a combination of earbud headphones, in combination with a smartwatch and/or a smartphone; a head mounted display other than smartglasses; a laptop computer with a web camera; and so forth.

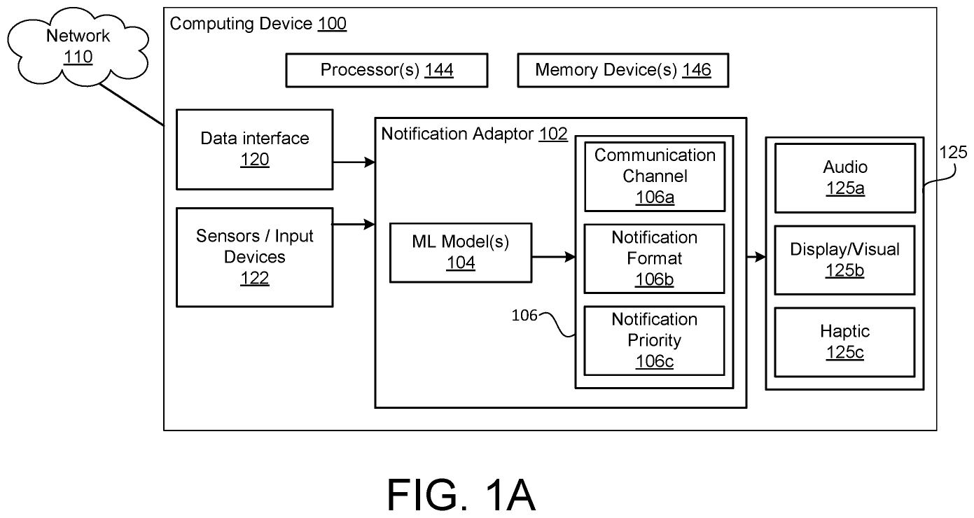

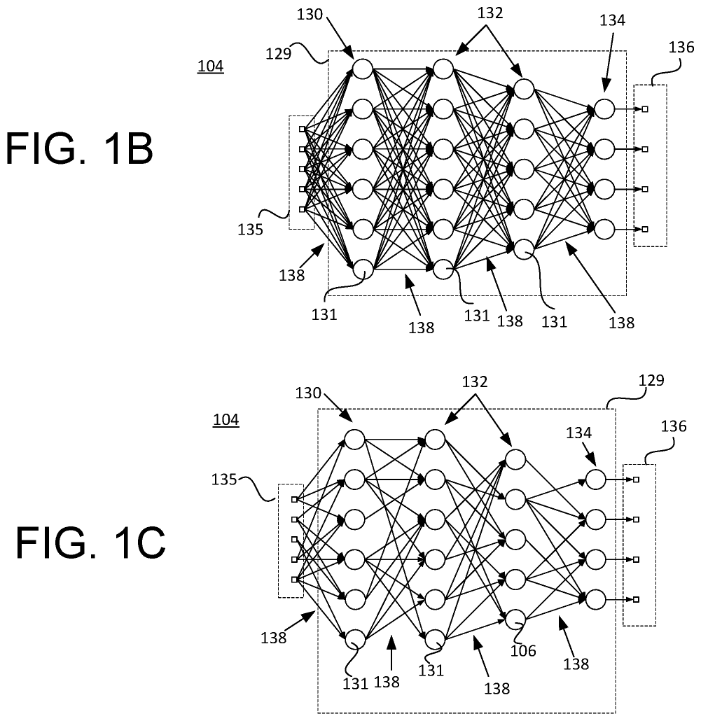

In some implementations, such as the example of FIGS. 1A-1C, described techniques can be implemented in a computing device 100 using one or more machine-learning (ML) models 104, though in some implementations, other approaches can be used, such as conventional programming logic. In the example implementation of FIGS. 1A-1C, the ML model(s) 104 can receive electronic communications, or indications of electronic communications, and/or data related to activities of a user of the computing device (e.g., sensory engagement of the user). In some implementations, electronic communications can be provided by or to a data interface 120 of the computing device 100, and/or can be received from a network 110, such as the Internet or other data network. Data related to activities, or sensory engagement of the user can be provided from sensors/input devices (hereafter “sensors 122) included in the computing device 100, and/or can be determine based on operations being performed by the computing device 100, e.g., audio streaming, display of text content, etc.

The ML model(s) 104 can then, based on the received information, select attributes 106 for a notification that is to be provided (e.g., to a user) by the computing device 100. For instance, as shown in FIG. 1A, the ML model(s) 104 can select a communication channel 106a (or communication channels) for providing a notification corresponding with the electronic communication, a format of the notification 106b, e.g., an amount of detail to include in the notification), and/or a priority (106c) associated with providing the notification. For instance, in some implementations, a selected format for a notification can take a number of forms, such as providing a meta-notification (e.g., an alert tone), displaying an alert icon, providing a summary (text and/or audio) of the associated electronic communication, or providing a detailed notification. The format of the provided notification can depend, at least in part, on an activity, or activities of the user (sensory engagement of the user, and/or an ambient environment of the user) that are determined using, e.g., the ML models(s) 104.

In example implementations, such as those described herein, the computing device 100 can include a wearable device which can include one or more sub-devices, where at least one of the sub-devices is a device capable of providing notifications to a user of the computing device 100. For instance, in some implementations, the computing device 100 may include a head-mounted display (HMD) device such as an optical head-mounted display (OHMD) device, a transparent heads-up display (HUD) device (e.g., in a vehicle), an augmented reality (AR) device, or other devices such as goggles or headsets having sensors, display, and computing capabilities. However, the described implementations are not limited to head-mounted display devices, where the computing device may include any type of wearable device such as earbuds, watches, fitness trackers, cameras, body sensors, and/or any type of computing device that can be worn by a person.

The computing device 100 can include smartglasses, where the smartglasses are implemented as an optical head-mounted display device designed in the shape of a pair of eyeglasses. For example, smartglasses are glasses that add information (e.g., project a display) alongside, or overlaid with what the wearer (user) views through the glasses. For example, the computing device 100 can include a display that is projected onto the field of view of the user. The display may include a liquid crystal display (LCD), a light-emitting diode (LED) display, an organic light-emitting display (OLED), an electro-phoretic display (EPD), or a micro-projection display adopting an LED light source. In some examples, the display may provide a transparent or semi-transparent display such that a user wearing the glasses can see images provided by the display but also information located in a field of view of the smartglasses behind the projected images. In some examples, the below description is explained in terms of smartglasses, but the described implementations may be applied to other types of wearable computing devices and/or combinations of mobile/wearable computing devices working together.

As shown in FIG. 1A, the computing device 100 includes one or more processor(s) 144, which may be formed in a substrate configured to execute one or more machine executable instructions or pieces of software, firmware, or a combination thereof. The processor(s) 144 can be semiconductor-based—that is, the processor(s) 144 can include processed semiconductor material that is configured to perform or execute digital logic. The computing device 100 can also include one or more memory devices 146. The memory devices 146 may include any type of storage device that stores information in a format that can be read and/or executed by the processor(s) 144. The memory device(s) 146 may store executable instructions that when executed by the processor(s) 144 cause the processor(s) 144 to perform any of the operations discussed herein. In some examples, the memory devices 146 which can store information received or generated by computing device 100. Also, the memory devices 146 may include applications and modules (e.g., notification adaptor 102, etc.) that, when executed by the processor(s) 144, perform the operations discussed herein. In some examples, such applications and modules may be stored in an external storage device and loaded into the memory devices 146 when needed for executing the processor(s) 144.

In some examples, the computing device 100 can include one or more server computers. In some examples, the computing device 100 can include one or more client computers (e.g., desktop computers, laptops, tablets, smartphones, etc.). In some examples, the computing device 100 can include one or more server computers and one or more client computers.

As noted above, the computing device 100 of FIG. 1A includes a notification adaptor 102. The notification adaptor 102 can be configured to select a communication channel 106a for providing a notification to be provided to a user (e.g., based on determined sensory engagement of a user), select a notification format 106b for notification to the provided to the user, and/or can determine a priority 106c of a notification. As discussed herein, in some implementation, the communication channel 106a that is selected by the notification adaptor 102 can be a communication channel that is different that the determines sensory channel (or channels) with which a user receiving the notification is currently engage. As shown in FIG. 1A, in this example, available output devices 125 for implementing a selected communication channel, or channels can include an audio output device 125a (such as one or more speakers), a display/visual output device 125b (such as a smartglasses display device) and a haptic output device 125c (such as a vibration device).

For instance, in the example of FIG. 1A, if the ML model(s) 104 determine that the user is engaged in a visual sensory channel, or is dominantly engaged in a visual sensory channel, the selected communication channel 106a can be an audio communication channel (125a), and/or a haptic communication channel (125c), e.g., a communication channel that is a different sensory channel than the determined user's engaged sensory channel. Similarly, if the ML model(s) 104 of the computing device 100 determine that the user is engaged in an audio sensory channel, or is dominantly engaged in an audio sensory channel, the selected communication channel 106a can be a visual communication channel (125b), and/or a haptic communication channel (125c). In another example, if the ML model(s) 104 determine that the user is equally engaged in both a visual sensory channel and an audio sensory channel, such as watching a movie, the selected communication channel can be a haptic communication channel (125c), so as not to disrupt the user's current sensory engagement, or sensory engagements. Such determinations can be implemented in a number of ways, such as using weighted measures or weighted estimates (e.g., in a ML model) of a user's sensory engagement(s), where weights can be respectively determined based on one or more factors, e.g., a specific activity, an amount of time a user has been engaged in an activity, a determination the user's ambient environment, and so forth. In some implementations other approaches for determining a user's dominant sensory engagement and, in turn, an appropriate notification communication channel, can be accomplished in other ways.

As noted above, the notification adaptor 102 can include one or more machine-learning (ML) models 104, where a ML model 104 is a predictive model. In some implementations, a ML model 104 includes a neural network. The ML model 104 may be an interconnected group of nodes, each node representing an artificial neuron. The nodes of the ML 104 can be connected to each other in layers, with the output of one layer becoming the input of a next layer. The ML model 104 receives an input (or inputs), e.g., by an input layer, and then transforms the received input(s) through a series of hidden layers and produces an output (or outputs) via the output layer. Each layer is made up of a subset of the set of nodes. The nodes in hidden layers are fully connected to all nodes in the previous layer and provide their output to all nodes in the next layer. The nodes in a single layer function independently of each other (i.e., do not share connections). Nodes in the output layer provide the transformed input(s), e.g., the outputs, to a requesting process. In some implementations, a ML model 104 can be a convolutional neural network, which is a neural network that is not fully connected. Convolutional neural networks therefore have less complexity than fully connected neural networks. Convolutional neural networks can also make use of pooling or max-pooling to reduce the dimensionality (and hence complexity) of the data that flows through the neural network, which can, as a result, reduce a level of computation used to arrive at a given output(s) based corresponding inputs. Accordingly, such approaches can make computation of the output(s) in a convolutional neural network faster than in fully-connected neural networks.

FIG. 1B illustrates a ML model 104 (e.g., a neural network) that is fully connected according to an aspect. The ML model 104 includes a set of computational processes for receiving a set of inputs 135 (e.g., input values) and generating a set of outputs 136 (e.g., output values). In some examples, each output value of the set of outputs 136 may represent an attribute 106 determined by the notification adaptor 102 (e.g., from the ML model(s) 104). In the example of FIG. 1B, the input values 135 may represent a received electronic communication and data regarding sensory engagement and/or an ambient environment of a user (e.g., from the sensors 122). The ML model 104 can include a plurality of layers 129, where each layer 129 includes a plurality of neurons 131. The plurality of layers 129 may include an input layer 130, one or more hidden layers 132, and an output layer 134. In some examples, each output of the output layer 134 represents a possible prediction (e.g., of a communication channel 106a, a notification format 106b, or a notification priority). In some examples, an output of the output layer 134 with a highest value can represent a desired (predicted, determined, etc.) output for a corresponding attribute 106.

In some examples, the ML model 104 is a deep neural network (DNN). For example, a deep neural network (DNN) may have one or more hidden layers 132 disposed between the input layer 130 and the output layer 134. However, the ML model 104 may be any type of artificial neural network (ANN) including a convolution neural network (CNN). The neurons 131 in one layer 129 are connected to the neurons 131 in another layer via synapses 138. For example, each arrow in FIG. 1B may represent a separate synapse 138. Fully connected layers 129 (such as shown in FIG. 1B) connect every neuron 131 in one layer 129 to every neuron in the adjacent layer 129 via the synapses 138.

Each synapse 138 can be associated with a weight. A weight is a parameter within the ML model 104 that transforms input data within the hidden layers 132. As an input enters the neuron 131, the input is multiplied by a weight value and the resulting output is either observed or passed to the next layer in the ML model 104. For example, each neuron 131 has a value corresponding to the neuron's activity (e.g., activation value). The activation value can be, for example, a value between 0 and 1 or a value between −1 and +1. The value for each neuron 131 is determined by the collection of synapses 138 that couple each neuron 131 to other neurons 131 in a previous layer 129. The value for a given neuron 131 is related to an accumulated, weighted sum of all neurons 131 in a previous layer 129. In other words, the value of each neuron 131 in a first layer 129 is multiplied by a corresponding weight and these values are summed together to compute the activation value of a neuron 131 in a second layer 129. Additionally, a bias may be added to the sum to adjust an overall activity of a neuron 131. Further, the sum including the bias may be applied to an activation function, which maps the sum to a range (e.g., zero to 1). Possible activation functions may include (but are not limited to) rectified linear unit (ReLu), sigmoid, or hyperbolic tangent (TanH).

FIG. 1C illustrates a ML model 104 that is partially connected. For example, similar to FIG. 1B, the ML model 104 includes a set of computational processes for receiving a set of inputs 135 (e.g., input values) and generating a set of outputs 136 (e.g., output values). Also, the ML model 104 of FIG. 1C includes a plurality of layers 129, where each layer 129 includes a plurality of neurons 131, and the layers 129 include an input layer 130, one or more hidden layers 132, and an output layer 134. The neurons 131 in one layer 129 are connected to neurons 131 in an adjacent layer 129 via the synapses 138. However, unlike FIG. 1B, the ML model 104 is not fully connected, where every neuron 131 in one layer 129 is not connected to every neuron in the adjacent layer 129 via the synapses 138.

Referring back to FIG. 1A, the notification adaptor 102 may receive an electronic communication (or an indication of an electronic communication), and data regarding sensory engagement and/or an ambient environment of a user to which a notification associated with the electronic communication is to be provided. In some implementations, the notification adaptor 102 may receive the electronic communication (or an indication thereof) from a data interface 120 of the computing device 100, and/or over a network 110 from a client computer, via the data interface 120. In some examples, the computing device 100 can be configured to provide the electronic communication, such as from an application or module being executed by the processor(s) 144, e.g., by executing machine instructions stored in the memory device(s) 146. The data regarding sensory engagement of the user and/or the ambient environment of the user can be provided by, e.g., the sensors 122, which can include an eye gaze tracking sensor, a location sensor (e.g., a GPS device), an IMU sensor, an image sensor, a microphone, a light sensor, etc.

The notification adaptor 102 may provide the electronic communication (or indication thereof) and data from the sensors 122 (and/or data from other components of the computing device 100) to the ML model(s) 104 to predict or determine the attributes 106 for a notification to be provided to a user. For instance, the ML model(s) 104 can be configured to predict (estimate, determine, etc.) sensory engagement/activities of the user (e.g., reading, having a conversation, driving, riding a bicycle, etc.), attributes of an ambient environment of the user (e.g., noise, lighting, physical location, objects in view, etc.), and/or information about the electronic communication (e.g., its content a source of the communication, interactions of the user with eh source of the communication, a location of the user, as some examples), and then determine or select attributes of the notification to be provided as output of the ML model(s) 104 based on provided inputs. The use of the ML model 104 to predict the attributes 106 may reduce the number of computation resources (e.g., processing power, memory, etc.) to adapt notifications provided to a particular user based on the considerations described herein, thereby improving the user experience by more intelligently notifying the user.

In some implementation, such as those described herein, the ML model(s) 104 may predict (estimate, determine, the attributes 106 for user notifications. In some implementations, the ML model(s) 104 can include different ML models for predicting, estimating, or determining different factors for selecting the attributes 106. For instance, the ML model(s) can include ML models that are respectively configured (trained) to estimate (predict, determine) whether a user is reading, whether there is reading material in view of the user, determine physical location of the user, determine if the user is engaged in a conversation with another person, determine a user's surrounding based on ambient noise, determine movement of user, determine if the user is watching a video or a movie, determine a level of sensory engagement of a user (e.g., based on how long a user has been engaged in a particular activity and/or sensory channel), importance of a message (e.g., based on its context and/or its source), as some examples. The particular ML model(s) included in the computing device 100 will, of course, depend on the particular implementation.

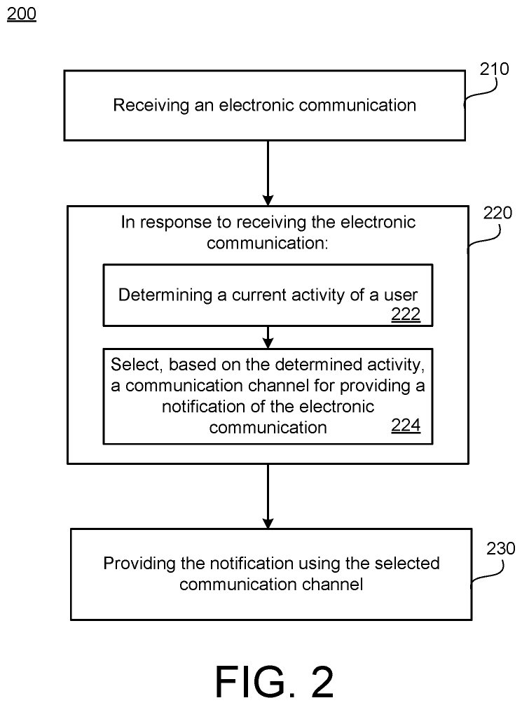

FIG. 2 is a flowchart illustrating a method 200 for providing adaptive notifications according to an aspect. While other arrangements are possible, in some implementations, the method 200 can be implemented using the computing device 100 of FIGS. 1A-1C, and corresponding approaches and techniques described herein. Accordingly, for purposes of discussion and illustration, the method 200 will be further described with respect to, at least, FIG. 1A. As shown in FIG. 2, the method 200 includes, at block 210, receiving an electronic communication, such as at the data interface 120. At block 220, the method 200 includes, at block 222, determining a current activity of a user (e.g., current sensory engagement(s) of the user), and, at block 224, selecting, based on the determined activity, a communication channel (106a) for providing a notification for the electronic communication of block 210. In some implementations, such as the example of FIGS. 1A-1C, the operations at block 220 can be performed using the ML model(s) 104 of the computing device 100. At block 230, the method 220 includes providing the output via an output device (or output devices) of the output devices 125 corresponding with the communication channel (or channels) selected at block 224. As described herein, determining the current activity (e.g., sensory engagement) of the user can be determined using data received from the sensor 222 (or other components of the computing device 100) as inputs to the ML model(s) 104.

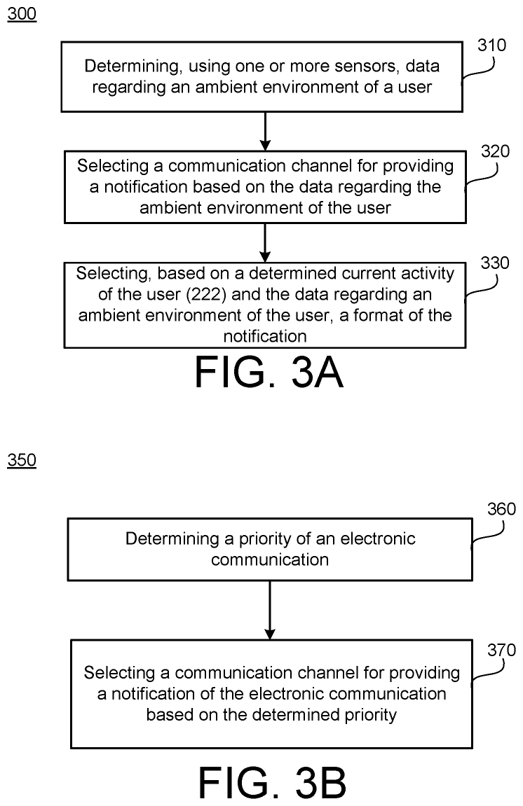

FIGS. 3A and 3B are flowcharts illustrating method operations that can be implemented, in some implementations, in conjunction with the method 200 of FIG. 2 for providing adaptive notifications, such as using the computing device 100 of FIGS. 1A-1C, and corresponding approaches and techniques described herein. Accordingly, for purposes of discussion and illustration, the method operations of FIGS. 3A and 3B will be further described with respect to, at least, FIG. 1A. For purposes of the discussion below, FIG. 3A is indicated as method 300, while FIG. 3B is indicated as method 360. As noted above, in some implementations, the operations of the methods 300 and 350 can be implemented in conjunction with other approaches for providing adaptive notifications, such as the method 200 of FIG. 2, and/or using other techniques described herein.

Referring to FIG. 3A, the method 300 includes, at block 310, in response to receiving an electronic communication, determining, using one or more sensors of the computing device 100, data regarding an ambient environment of the user. At block 320, the method 300 includes selecting a communication channel of the computing device for providing a notification based on the data regarding the ambient environment of the user, which can be done in combination with the data regarding sensory engagement of the user (blocks 222 and 224). Further, at block 330, the method 300 includes selecting, based on the determined current activity of the user and the data regarding an ambient environment of the user, a format of the notification. For instance, if it is determined that there the user has a high level of sensory engagement (e.g., visual and/or audio sensory engagement), such as being in a classroom lecture taking notes, it may be decided to provide a minimal, non-disruptive notification, such as a haptic notification, or a meta notification, such as an alert tone. However, if a priority of the message is determined to be high, e.g., using the ML model(s) 104, a more detailed notification may be provided regardless of the determined sensory engagement of the user.

Referring to FIG. 3B, the method 350 includes, at block 360, determining, by the computing device 100, a priority of the electronic communication, such as using the approaches described herein. At block 370, the method 350 includes selecting the communication channel (or channels) of the computing device 100 for providing the notification based on the determined priority of the electronic communication, which, in some implementations, can be done in conjunction with other factors for determining a communication channel, such as utilizing the ML model(s) 104 to make such determinations.

In example implementations of the computing device 100, the method 200, the method 300 and/or method 350, determining a current activity of a user of the computing device can include determining that the user is visually engaged (e.g., is engaged in a visual sensory channel). In this example, in response to determining that the user is visually engaged, the described techniques can include selecting, e.g., by one or more ML models, an audio communication channel, such as the audio output 125a, for providing a notification of the electronic communication, e.g., a notification in a different sensory channel than the user's current sensory engagement. Similarly, if it is determined a user (e.g., of the computing device 100) is auditorily engaged (e.g., is engaged in an audio sensory channel), the described techniques can include selecting, e.g., by one or more ML models, a visual communication channel, such as a display of the computing device 100, and/or a haptic communication channel to communicate a notification to the user, e.g., provide the notification in a different sensory channel than the user's current sensory engagement.

In some implementations, such as for notifications that are determined to have high importance, and/or notifications provided in chaotic ambient environments, as two examples, an audio communication channel 106a can be selected for providing the associated notification, and the audio notification can be provided beginning with the user's name. Such an approach can increase the likelihood that the provided audio notification will capture the user's attention, e.g., divert their attention from any current sensory engagement, whether visual and/or or auditory.

In some implementations, notifications can be provided based on delivery time widows, where a delivery time window can be determined, e.g., by the ML model(s) 104, based on various factors, such as those described herein. For instance, such delivery time windows can be determined based on an importance of the notification, current sensory engagement of the user, and so forth.

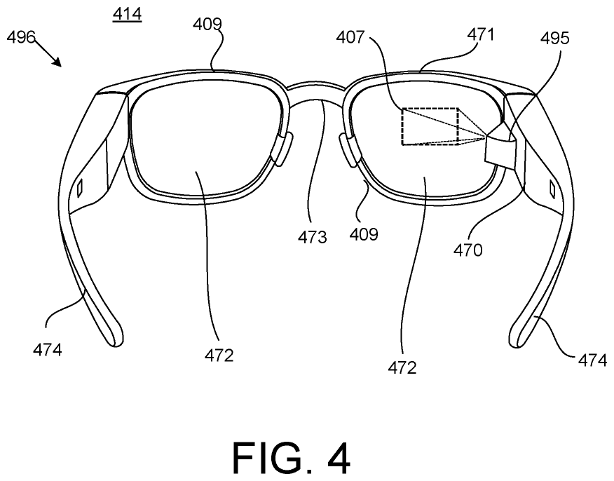

FIG. 4 illustrates an example of smartglasses 496 that can, in some implementations, be included in, or implement the computing device 100 of FIG. 1A, and which can implement the approaches for providing adaptive user notifications described herein, according to an aspect. In this example, the smartglasses 496 are glasses that add information (e.g., project a display 407) alongside, or overlaid with what the wearer (a user) views through the glasses. For example, the smartglasses 496 may include a display device 495 configured to project the display 407. In some examples, the display device 495 may include a see-through near-eye display. For example, the display device 495 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 472, next to content (for example, text notifications, digital images, user interface elements, virtual content, and the like) generated by the display device 495. In some implementations, waveguide optics may be used to depict content on the display device 495.

In some examples, instead of projecting information, the display 407 includes an in-lens micro display. In some examples, the display 407 is referred to as an eye box. In some examples, smartglasses 496 (e.g., eyeglasses or spectacles), are vision aids, including lenses 472 (e.g., glass or hard plastic lenses) mounted in a frame 471 that holds them in front of a person's eyes, typically utilizing a bridge portion 473 over the nose, and arm portions 474 (e.g., temples or temple pieces) which rest over the ears. The bridge portion 473 may connect rim portions 409 of the frame 471. The smartglasses 496 of FIG. 4 include an electronics component 470 that can include circuitry of the smartglasses 496, such as the sensors 122 of FIG. 1A. In some examples, the electronics component 470 can be included or integrated into one of the arm portions 474 (or both of the arm portions 474) of the smartglasses 496.

The smartglasses 496 can also include an audio input device, an audio output device (such as, for example, one or more speakers), an illumination device, a sensing system (such as including sensors such as those described herein), a control system, at least one processor, and/or an outward facing image sensor, or camera. In some examples, the smartglasses 496 may include a gaze tracking device including, for example, one or more sensors, to detect and track eye gaze direction and movement. e.g., which can be used to determine engagement of a user in a visual sensory channel. Data captured by the sensor(s) may be processed to detect and track gaze direction and movement as a user input. In some examples, the sensing system may include various sensing devices and the control system may include various control system devices including, for example, one or more processors operably coupled to the components of the control system. In some implementations, the control system may include a communication module providing for communication and exchange of information between the wearable computing device and other external devices.

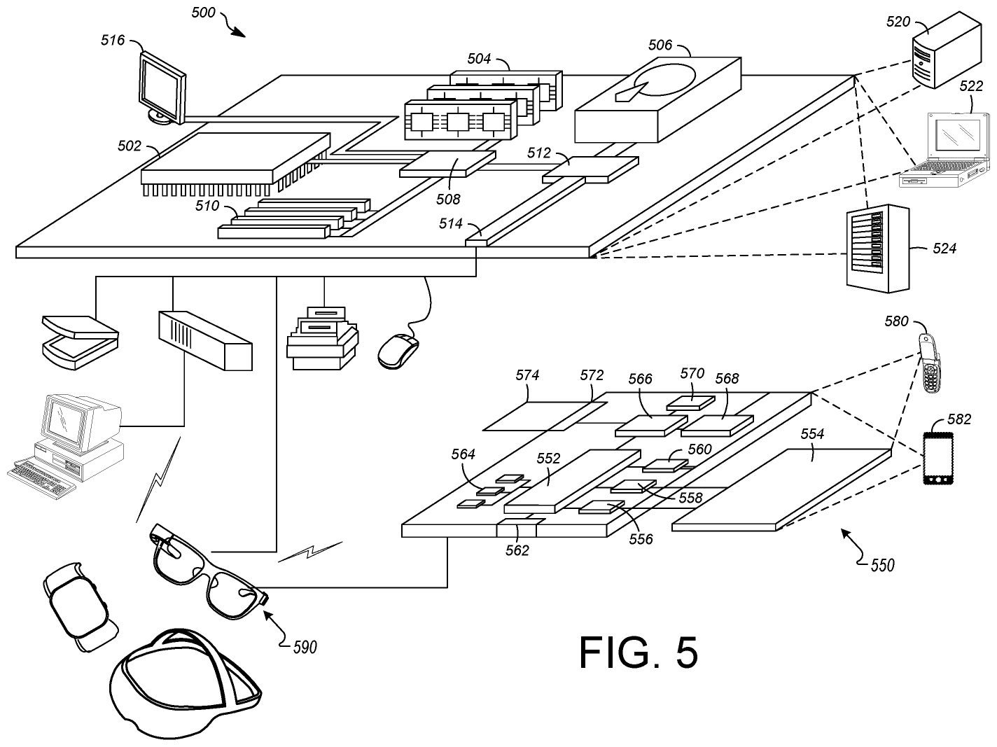

FIG. 5 illustrates an example of a computer device 500 and a mobile computer device 550, which may be used with the techniques described here. The computing device 500 includes a processor 502, memory 504, a storage device 506, a high-speed interface 508 connecting to memory 504 and high-speed expansion ports 510, and a low-speed interface 512 connecting to low-speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high-speed controller 508 manages bandwidth-intensive operations for the computing device 500, while the low-speed controller 512 manages lower bandwidth-intensive operations. Such allocation of functions is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display), and LED (Light Emitting Diode) or an OLED (Organic Light Emitting Diode) display, or other appropriate display technology. The display interface 556 may include appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In-Line Memory Module) card interface. Such expansion memory 574 may provide extra storage space for device 550 or may also store applications or other information for device 550. Specifically, expansion memory 574 may include instructions to carry out or supplement the processes described above and may include secure information also. Thus, for example, expansion memory 574 may be provided as a security module for device 550 and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, Wi-Fi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in the figure can include sensors that interface with an AR headset/HMD device 590 to generate an augmented environment for viewing inserted content within the physical space. For example, one or more sensors included on a computing device 550 or other computing device depicted in the figure, can provide input to the AR headset 590 or in general, provide input to an AR space. The sensors can include, but are not limited to, a touchscreen, accelerometers, gyroscopes, pressure sensors, biometric sensors, temperature sensors, humidity sensors, and ambient light sensors. The computing device 550 can use the sensors to determine an absolute position and/or a detected rotation of the computing device in the AR space that can then be used as input to the AR space. For example, the computing device 550 may be incorporated into the AR space as a virtual object, such as a controller, a laser pointer, a keyboard, a weapon, etc. Positioning of the computing device/virtual object by the user when incorporated into the AR space can allow the user to position the computing device so as to view the virtual object in certain manners in the AR space. For example, if the virtual object represents a laser pointer, the user can manipulate the computing device as if it were an actual laser pointer. The user can move the computing device left and right, up and down, in a circle, etc., and use the device in a similar fashion to using a laser pointer. In some implementations, the user can aim at a target location using a virtual laser pointer.

In some implementations, one or more input devices included on, or connect to, the computing device 550 can be used as input to the AR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 550 when the computing device is incorporated into the AR space can cause a particular action to occur in the AR space.

In some implementations, a touchscreen of the computing device 550 can be rendered as a touchpad in AR space. A user can interact with the touchscreen of the computing device 550. The interactions are rendered, in AR headset 590 for example, as movements on the rendered touchpad in the AR space. The rendered movements can control virtual objects in the AR space.

In some implementations, one or more output devices included on the computing device 550 can provide output and/or feedback to a user of the AR headset 590 in the AR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 550 may appear as another object in a computer-generated, 3D environment. Interactions by the user with the computing device 550 (e.g., rotating, shaking, touching a touchscreen, swiping a finger across a touch screen) can be interpreted as interactions with the object in the AR space. In the example of the laser pointer in an AR space, the computing device 550 appears as a virtual laser pointer in the computer-generated, 3D environment. As the user manipulates the computing device 550, the user in the AR space sees movement of the laser pointer. The user receives feedback from interactions with the computing device 550 in the AR environment on the computing device 550 or on the AR headset 590. The user's interactions with the computing device may be translated to interactions with a user interface generated in the AR environment for a controllable device.

In some implementations, a computing device 550 may include a touchscreen. For example, a user can interact with the touchscreen to interact with a user interface for a controllable device. For example, the touchscreen may include user interface elements such as sliders that can control properties of the controllable device.

Computing device 500 is intended to represent various forms of digital computers and devices, including, but not limited to laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
receiving, by a computing device, an electronic communication;
in response to receiving the electronic communication:
determining, by the computing device, current sensory activity of a user of the computing device; and
selecting, based on the determined current sensory activity of the user, a communication channel of the computing device for providing a notification of the electronic communication; and
providing the notification using the selected communication channel of the computing device.

2. The method of claim 1, wherein determining the current sensory activity of the user includes determining the current sensory activity using one or more sensors included in the computing device.

3. The method of claim 1, further comprising, in response to receiving the electronic communication:
determining, using one or more sensors of the computing device, data regarding an ambient environment of the user, selecting the communication channel of the computing device for providing the notification being further based on the data regarding the ambient environment of the user.

4. The method of claim 3, wherein:
selecting the communication channel of the computing device for providing the notification includes selecting multiple communication channels of the computing device for providing the notification; and
providing the notification includes providing the notification using the selected multiple communication channels of the computing device.

5. The method of claim 3, further comprising:
selecting, based on the determined current sensory activity of the user and the data regarding an ambient environment of the user, a format of the notification.

6. The method of claim 1, wherein selecting the communication channel of the computing device for providing the notification includes selecting the communication channel of the computing device for providing the notification using at least one machine learning (ML) model.

7. The method of claim 1, further comprising, in response to receiving the electronic communication:
determining, by the computing device, a priority of the electronic communication,
the selecting the communication channel of the computing device for providing the notification being further based on the determined priority of the electronic communication.

8. The method of claim 1, wherein:
determining the current sensory activity of a user of the computing device includes determining the user is visually engaged; and
in response to determining that the user is visually engaged, selecting the communication channel of the computing device for providing a notification of the electronic communication includes selecting an audio communication channel of the computing device.

9. The method of claim 1, wherein:
determining the current sensory activity of a user of the computing device includes determining the user is auditorily engaged; and
in response to determining that the user is auditorily engaged, selecting the communication channel of the computing device for providing a notification of the electronic communication includes selecting a text communication channel of the computing device.

10. The method of claim 1, wherein:
the selected communication channel of the computing device for providing the notification includes an audio output channel; and
providing the notification includes providing, via the audio output channel, an audio notification, the audio notification beginning with a name of the user.

11. The method of claim 1, wherein providing the notification includes providing the notification in accordance with a time delivery window.

12. The method of claim 1, wherein the electronic communication is:
generated by the computing device; or
received by the computing device via a data communication network.

13. A computing device, comprising:
at least one processor; and
a non-transitory computer-readable medium storing executable instructions that, when executed by the at least one processor, cause the computing device to:
receive an electronic communication;
in response to receiving the electronic communication:
determine current sensory activity of a user of the computing device; and
select, based on the determined current sensory activity of the user, a communication channel of the computing device for providing a notification of the electronic communication; and
provide the notification using the selected communication channel of the computing device.

14. The computing device of claim 13, wherein the executable instructions include instructions that, when executed by the at least one processor, cause the computing device to:
determine, using one or more sensors of the computing device, data regarding an ambient environment of the user, selecting the communication channel of the computing device for providing the notification being further based on the data regarding the ambient environment of the user.

15. The computing device of claim 14, wherein the executable instructions include instructions that, when executed by the at least one processor, cause the computing device to:
determine the current sensory activity of the user using the one or more sensors of the computing device,
the one or more sensors including at least one of:
an eye gaze sensor;
a location sensor;
an inertial measurement unit (IMU) senor;
an image sensor;
a microphone; or
a light sensor.

16. The computing device of claim 13, wherein the computing device includes a wearable device.

17. A non-transitory computer-readable medium storing executable instructions that, when executed by at least one processor, cause a computing device to:
receive an electronic communication;
in response to receiving the electronic communication:
determine current sensory activity of a user of the computing device; and
select, based on the determined current sensory activity of the user, a communication channel of the computing device for providing a notification of the electronic communication; and
provide the notification using the selected communication channel of the computing device.

18. The non-transitory computer-readable medium of claim 17, wherein the executable instructions include instructions that, when executed, cause the at least one processor to:
determine, using one or more sensors of the computing device, data regarding an ambient environment of the user, selecting the communication channel of the computing device for providing the notification being further based on the data regarding the ambient environment of the user.

19. The non-transitory computer-readable medium of claim 18, wherein the executable instructions include instructions that, when executed by the at least one processor, cause the computing device to:
select, based on the determined current sensory activity of the user and the data regarding an ambient environment of the user, a format of the notification.

20. The non-transitory computer-readable medium of claim 17, wherein the executable instructions include instructions that, when executed by the at least one processor, cause the computing device to:
determine, by the computing device, a priority of the electronic communication, selecting the communication channel of the computing device for providing the notification being further based on the determined priority of the electronic communication.
